(19) United States
(12) Patent Application Publication
(10) Pub. No.: US 2007/0264861 A1
(43) Pub. Date: Nov. 15, 2007

(54) Crimped Connection

(76) Inventors: Stefan Jurgen Scheuermann, Frankfurt/Main (DE); Christof Kirsch, Niddatal (DE); Thomas Chaloupka, Burladingen (DE)

Correspondence Address: WALTER OTTESEN, PO BOX 4026, GAITHERSBURG, MD, 20885-4026, US

(21) Appl. No.: 11/665,426

(22) PCT Filed: Sep. 8, 2005
(86) PCT No.: PCT/EP05/09637

§ 371 Date: Apr. 27, 2007

(30) Foreign Application Priority Data
Oct. 14, 2004 (DE) 102004050001.0

(51) Int. Cl. H01R 4/10

(52) U.S. Cl. 439/421

(57) ABSTRACT

The invention relates to a crimped connection (1) between the end (2) of an electrical conductor (3) which is made of high-grade steel and a connector (4) with the end (2) of the electrical conductor (3) being disposed in the compressed connector (4). According to the invention, the end (5) of an electrical conductor (6) made of copper is additionally placed in the connector (4).

The invention relates to a crimped connection between the end of an electrical conductor of high-grade steel or a similar hard and tough material and a connector, the end of the electrical conductor being arranged in the compressed connector.

In electrical installation, crimping is the term used for mechanically compressing a sleeve to produce a solid mechanical connection between a conductor and a connector. A person skilled in the art knows of various types of compressible connectors, which are selected according to conditions of use. So-called cable lugs and butt connectors are mentioned here only by way of example.

An electrical conductor is understood here and hereafter as meaning one or more wires or a bundle of stranded wires. Such a conductor may have an electrically insulating sheathing.

Electrical conductors of high-grade steel are used for example in heatable tubes and serve for heating up the media flowing in these tubes. A heatable tube with an electrical heating conductor is known for example from DE 102 01 920 A1, the heating conductor extending over at least part of the length of the tube. The heating conductor is usually embedded in a layer of the tube. In the case of a multilayered tube, the heating conductor may also be arranged between two layers. The ends of the heating conductor are exposed in order to allow them to be connected to a voltage source required for operating the heating conductor. For this purpose, the exposed ends are led to an electrical connecting device and connected to it. Then a voltage source can be connected to the connecting device.

The connection of the ends of the heating conductor to the connecting device usually takes place via the crimped connection mentioned at the beginning.

Such crimped connections should be as gastight as possible.

In the case of a gastight connection, conductors and connectors are deformed and pressed together so firmly that there are no longer any intermediate spaces. Neither a liquid medium nor a gaseous medium can penetrate into the crimp under normal atmospheric conditions. As a result, oxidation between the pressed individual wires is prevented and an increase in the crimping resistance is virtually ruled out.

Inadequate pressing disadvantageously has the consequence that the conductor can be pulled out of the connection. In addition, however, intermediate spaces in which oxidation can occur also remain. Oxidation results in an increase in the contact resistance. An increased resistance is in turn disadvantageous for signal transmission, since the signal flow is damped or attenuated, and for power transmission, since it causes a loss of energy and heating up of the contacts and an accompanying risk of fire.

Therefore, the individual conductors must be pressed right one against the other and deformed by an adequately great crimping pressure so that pressing without any appreciable intermediate spaces is achieved.

However, it has been found that such pressing is scarcely possible in practice in the case of electrical conductors of high-grade steel, in particular in the case of the normally used heating conductors of heatable tubes. This is so because heating conductors consist of materials which are extremely tough and hard and therefore can only be deformed with difficulty. Normal crimped connections of such electrical conductors are therefore not gastight, as a result of which the adverse consequences already described arise. These non-gastight crimped connections can therefore only be used for currents of a few amperes.

The invention is based on the object of providing a gastight crimped connection between the end of an electrical conductor of high-grade steel or a similar hard and tough material and a connector.

In the case of a crimped connection according to the preamble of claim 1, this object is achieved according to the invention by the features of the characterizing clause of claim 1. Developments and advantageous embodiments will become evident from the dependent claims.

The fact that the end of an electrical conductor of copper is additionally arranged in the connector surprisingly easily achieves the effect that the crimped connection between the end of the electrical conductor of high-grade steel or a similar hard and tough material and the connector is gastight.

This is so because it has been found that the end of the electrical conductor of copper additionally arranged in the connector is deformed during the compressing of the connector in such a way that the intermediate spaces formed by the end of the electrical conductor of high-grade steel or a similar hard and tough material are filled. The end of the electrical conductor of copper acts in a manner of a filling material during the compression of the connector.

The gastight crimped connection obtained according to the invention has the effect of preventing oxidation between the pressed individual wires and/or stranded wires and of virtually ruling out an increase in the crimping resistance.

An embodiment of the invention provides that the electrical conductor of high-grade steel is a heating conductor of a heatable tube.

As a result, the ends of the heating conductor can for the first time be connected to a voltage source without oxidation of the crimped connection and an increase in the contact resistance having to be feared. The risk of contacts heating up, and therefore the risk of fire, is avoided.

The electrical conductor may comprise one or more wires and/or a bundle of stranded wires. A bundle of stranded wires has the advantage that, when the connector is compressed, they are already joined more closely together without deformation and fill initial intermediate spaces. Finally, just a slight deformation of the copper stranded wires is required to fill the last remaining intermediate spaces.

In an advantageous embodiment of the invention, the end of the electrical conductor consisting of copper that is not arranged in the connector is connected to a voltage source.

Since the electrical conductor of copper has a very much lower resistance than the electrical conductor of high-grade steel, it is possible in this embodiment of the invention to choose the electrical conductor of copper to be of virtually any desired length, without having to fear any adverse influence on the resistance of the electrical conductor of high-grade steel. If the electrical conductor of high-grade steel is a heating conductor, the heating resistance consequently remains unchanged irrespective of the length of the electrical conductor of copper. The heating output is not influenced by the electrical conductor of copper. The electrical conductor advantageously essentially forms a contact bridge.

Furthermore, it is provided that the connector is a cable lug. Such a connector has proven to be particularly suitable for receiving the ends of the electrical conductors in its sleeve-like portion in such a way that the latter can subsequently be compressed or pressed in a gastight manner according to the invention.

As an alternative to this, it is provided that the connector is a butt connector. This connector is also particularly suitable for receiving the ends of the electrical conductors from opposite sides in its sleeve-like portion in such a way that the latter can subsequently be compressed or pressed in a gastight manner according to the invention.

The invention is explained below on the basis of two exemplary embodiments, which are represented in the drawing, in which:

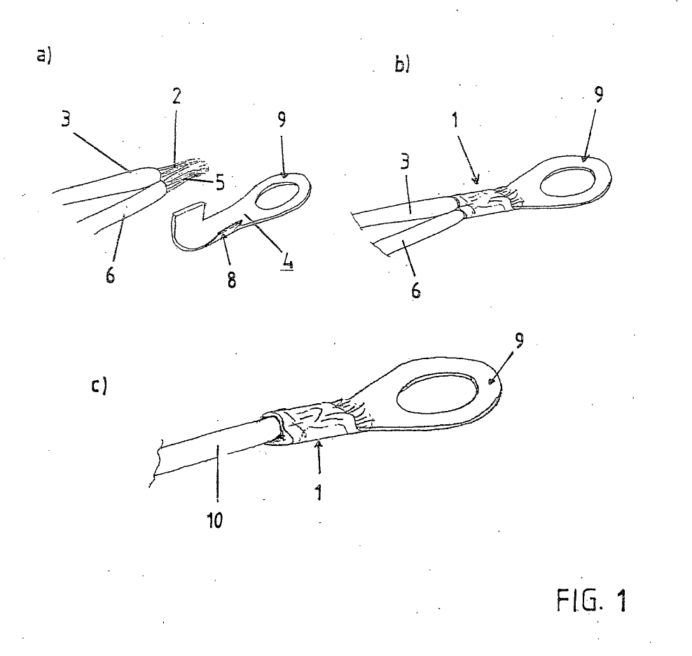

FIG. 1 shows a schematic representation of the crimped connection according to the invention with a cable lug as the connector

a) before compressing,

b) after compressing and

c) after compressing, and

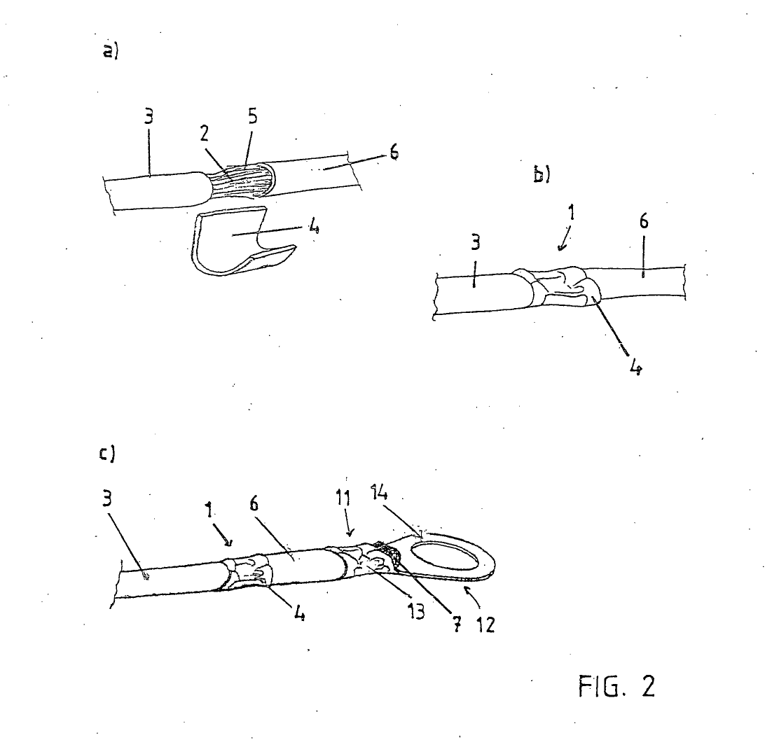

FIG. 2 shows a schematic representation of the crimped connection according to the invention with a sleeve-like clip as the connector

a) before compressing,

b) after compressing and

c) after compressing.

In both FIGS. of the drawing, the same parts are always provided with the same reference numerals.

In FIG. 1, the crimped connection 1 according to the invention is represented with a cable lug as the connector 4.

As can be seen from a), the cable lug comprises a sleeve-like portion 8 and an eyelet-like contact 9 for connection to a voltage source (not shown). Apart from this connector 4, the crimped connection 1 comprises the end 2 of the electrical conductor 3 of high-grade steel and the end 5 of the electrical conductor 6 of copper. The electrical conductor 6 of copper can be chosen to be relatively short. The ends (2, 5) comprise a multiplicity of stranded wires.

To produce the gastight crimped connection 1, the ends (2, 5) are arranged in the sleeve-like portion 8 of the connector 4. Subsequently, the sleeve-like portion 8 is compressed in such a way that the stranded wires of copper are pressed into the intermediate spaces that are present and fill the same completely.

In b), the gastight crimped connection 1 obtained is shown after compressing. Subsequently, the electrical conductors (3, 6) can be jointly sheathed. The joint sheathing 10 is shown in c).

FIG. 2 shows the crimped connection 1 according to the invention with a sleeve-like clip similar to a butt connector 4.

The crimped connection 1 also includes the end 2 of the electrical conductor 3 of high-grade steel and the end 5 of the electrical conductor 6 of copper. The electrical conductor 6 of copper serves in a manner of a contact bridge and can be chosen to be of any desired length, according to the conditions of use. The ends (2, 5) include a multiplicity of stranded wires.

To produce the gastight crimped connection 1, the ends (2, 5) are arranged in the sleeve-like clip 4. For this purpose, the ends (2, 5) are brought together from opposite sides with the stranded wires of the ends (2, 5) touching one another, preferably becoming intertwined, over a predetermined length. Subsequently, the sleeve-like clip is compressed in such a way that the stranded wires of copper are pressed into the intermediate spaces that are present within the connector in order to fill the same completely.

In b) and c), the gastight crimped connection 1 is shown after compressing.

The end 7 of the electrical conductor 6 of copper, which is not arranged in the connector 4, preferably has—as shown in c)—a further crimped connection 11. In this connection 11, the end 7 is positioned in a connector designed as a cable lug 12. The cable lug 12 comprises a sleeve-like portion 13 and a contact 14 for connection to a voltage source (not shown). Consequently, the electrical conductor 6 of copper serves in a manner of a contact bridge.

### LIST OF REFERENCE NUMERALS

(constituting part of the description)

1 crimped connection
2 end of high-grade steel
3 electrical conductor of high-grade steel
4 connector
5 first end of copper
6 electrical conductor of copper
7 second end of copper
8 sleeve-like portion
9 contact
10 sheathing
11 crimped connection
12 cable lug
13 sleeve-like portion
14 contact

1-6. (canceled)

7. A crimped connection comprising:
a first electrical conductor having a first end portion and being of high-grade steel or similar hard and tough material;
a second electrical conductor having a second end portion and being of copper; and,
a connector holding said first and second end portions and being compressed upon said end portions.

8. The crimped connection of claim 7, wherein said first electrical conductor is a heating conductor of a heatable tube.

9. The crimped connection of claim 7, wherein each of said electrical conductors comprises one or more wires.

10. The crimped connection of claim 7, wherein each of said electrical conductors comprises a bundle of stranded wires.

11. The crimped connection of claim 7, wherein said second electrical conductor has a remote end portion remote from said second end portion disposed in said connector; and, said remote end portion is connected to a voltage source.

12. The crimped connection of claim 7, wherein said connector is a cable lug.

13. The crimped connection of claim 7, wherein said connector is a butt connector.

14. A crimped connection comprising:
a first electrical conductor having a first end portion and being made of high grade steel or similar hard and tough metal material;
a second electrical conductor having a second end portion and being made of copper;
a connector holding said first and second end portions in side-by-side relationship;
said first electrical conductor being made of stranded wire and said first end portion comprising a plurality of strands defining spaces between said strands; and,
said connector being compressed down upon said first and second end portions to form a crimped connection so as to cause the copper of said second end portion to be deformed and fill out said spaces whereby a gastight crimped connection is formed to prevent oxidation between said end portions.
